(19) United States
(12) Patent Application Publication
(10) Pub. No.: US 2008/0134981 A1
(43) Pub. Date: Jun. 12, 2008

(54) Disposable cat litter scoop with collection system

(76) Inventors: Albert A. Selenke, Denver, CO (US); William M. Selenke, Cincinnati, OH (US)

Correspondence Address: William M. Selenke, 5 Drummond St., Cinciinnati, OH, 45218, US

(21) Appl. No.: 11/983,998

(22) Filed: Nov. 13, 2007

Related U.S. Application Data
(60) Provisional application No. 60/874,355, filed on Dec. 12, 2006.

(51) Int. Cl. A01K 29/00

(52) U.S. Cl. 119/161

(57) ABSTRACT

The invention is a bag-scoop device to collect cat litter waste. The scoop part is a flat construct which readily folds and squeezes into a disposable scoop or shovel. The are holes in the dish of the shovel to sieve out small litter particles and retains the aggregated waste balls. The manufactured invention includes a bag that contains the scoop and attached frame to hold the bag open to receive the aggregated waste balls. The frame automatically is placed in the opening of the bag as the scoop is removed. In a second option a scraper part is attached to the scoop.

### FIELD OF INVENTION

The invention is concerned with maintaining cat litter boxes. More specifically it is concerned with litter that clumps when the feline waste is emitted into the litter box. Cat litter that clumps around cat waste is a common commercial product. In operation, the cat pet owner uses a plastic scoop with holes such that the cat litter is removed and the clumps of solidified feline waste is then disposed of in a bag and which bag is disposed into the trash. The present invention is concerned with disposable scoops with holes. Likewise, the present invention in one embodiment is part of a bag collection kit. Optionally this kit has disposable sanitary gloves

### BACKGROUND OF INVENTION

The production of waste or feces by animals is an essential part of nature. In the wild, animal feces with the aid of dung beetles is rapidly broken down and becomes part of a natural fertilizer of nature. Domestic cats are optimal pets in an urban setting. By their very nature domestic felines are quite fastidious. That is if an area or box is provided with particulate matter the cat will paw a small hole in that matter or litter. The cat will then eliminate, and after elimination that cat will cover up the feces or urine. Many commercial litters contain special agents that produce balls or large particles that enclose the feces or urine in a layer of the litter. This is a significant advance in the disposal of domestic feline waste. That is one or two eliminations of the cat will not spoil the litter causing its disposal. If the clumps of waste are removed in a timely manner, the owner will significantly lengthen the useful life of the litter. In fact the useful life of ordinary litter, without clumping material, can be extended if the areas of urine and feces are removed.

### SUMMARY OF INVENTION

A scoop device to collect cat litter waste has a scoop with a dish part and a handle composite. The handle composite is subdivided into an upward foldable right handle support with a right crease to make a right center support and right outer support. The upward foldable left handle support has a left crease to make a left center support and a left outer support. The right center support, left center support, right outer support, and left outer support are each about one-fourth the width of the handle composite. Midway between the right shovel handle section and the left shovel handle section is a handle groove that allows downward bends for left center support and right center support. That handle groove extends to about one-third to one-half of scoop device and continues as a right bifurcation bend and left bifurcation bend.

The right bifurcation bend and left bifurcation bend are at obtuse angles and connect to right crease line and left crease line as an angle point. The right handle support continues to become right dish side and the left handle support continues to become left dish side. The right crease bend, and left crease bend makes a right dish shoulder and a left dish shoulder. The right bifurcation bend and the left bifurcation bend in cooperation with a kite shaped portion created in part by right bifurcation bend and left bifurcation bend right crease line and left crease line as an angle point. The right handle support continues to become right dish side and the left handle support continues to become left dish side. The right crease bend and left crease bend makes a right dish shoulder and a left dish shoulder. The right bifurcation bend and the left bifurcation bend in cooperation with a kite shaped portion created in part by right bifurcation bend and left bifurcation bend provide a top wall of dish part. The right dish shoulder, left dish shoulder, a kite shaped portion, right dish side, and left dish side provide walls for dish base with holes. This scoop device may have a scraper end. Likewise, the device may have a barrier end extending from dish base with bend fold. On the sides of that scope barrier are a first and a second barrier tabs. The right dish side extends to a first v point with a first tab hole which receives first barrier tab and the left dish side extends to second v point with a second tab hole which receives second barrier tabs.

In a second embodiment of the device a scoop with a dish part and a handle composite attached via perforations to a bag box part. The bag box part has a scraper leaf end and a perforated end, and a box holder frame. The box holder frame is connected with perforations to dish segment end of scoop part. The box holder frame is defined by a bag holder opening door which has a bend line proximal to box part scraper end. The bag holder opener has a hand slot cut opening. The scraper end leaf is defined by a bend slash attached to box holder frame. This second embodiment has a closable bag which contains the inventive scoop and bag holder opener. Optionally this second embodiment has a barrier end extending from dish base with bend fold. On sides of scope barrier are barrier tabs. These barrier tabs are received by tab holes in barrier points that extends from the dish side. The inventive device may be a kit which includes disposable gloves and wipes.

### BRIEF DESCRIPTION OF FIGURES

FIG. 1 show details of the scoop part of the device to collect and sequester cat litter box waste.

FIG. 2 shows a flat semi rigid construct for the removal of clumps form cat litter with a bag box part connected with perforations to scoop part.

FIG. 3 shows the pattern of folds for flat semi rigid construct can be converted into a scoop with holes in dish area.

FIG. 4 shows a side views of device partially folded in collection bag.

FIG. 5 shows a perspective view of device partially removed from bag.

FIG. 6 shows top view of collection bag with access hole.

FIG. 7 shows the isolated scoop part as it is being squeezed into a scoop form.

FIG. 8 the isolated scoop part squeezed into the final form for removing litter.

FIG. 9 shows an alternate embodiment of the device which was described in FIG. 2.

FIG. 10 shows isolated unassembled scoop device with scoop barrier.

FIG. 11 shows alternate embodiment of FIG. 9 assembled for use.

FIG. 12 shows that an assembled device may have handle composite and dish section in either a a straight line assembly or at an angled assemble.

### DETAILED DESCRIPTION OF FIGURES

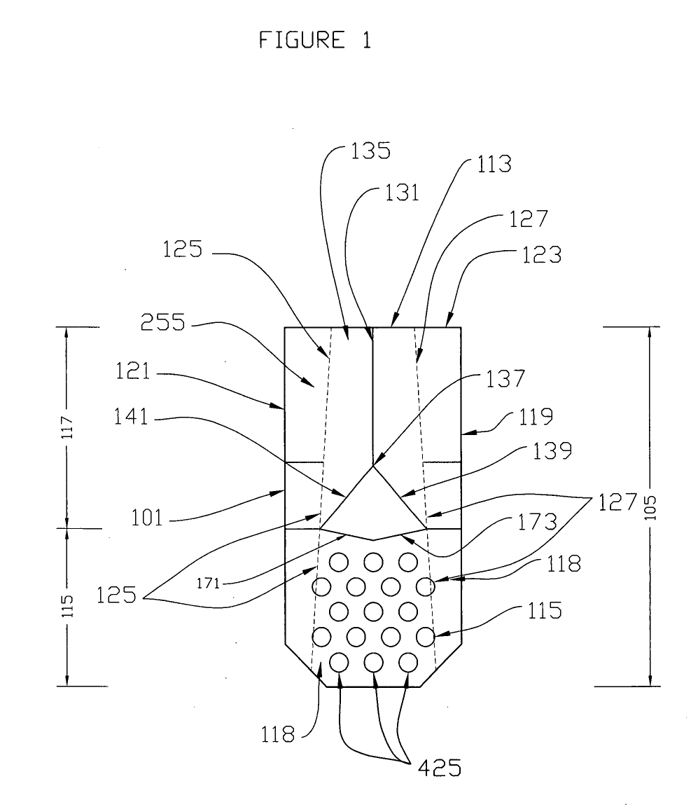

FIG. 1 shows details of the scoop part 105 of the device to collect and sequester cat litter waste. Scoop part 105 has a handle composite 117 and a dish section 115. Dish section 115 has dish base 118. The shovel handle composite 117 has a right handle support 119 and a left handle support 121. Right handle support 119 has a right crease 127 to make a right center support 113 and right outer support 123. Right crease 127 allows a downward bend between right center support 113 and right outer support 123. Left crease 125 allows a downward bend for left center support 135 and left outer support 255.

Midway between right shovel handle section 119 and left shovel handle section 121 is handle groove 131 that allows downward bends for left center support 135 and right center support 113. Handle groove 131 extends to about one-third to one-half of scoop part 105 to end at angle point 137 and continues as a right bifurcation bend 139 and left bifurcation bend 141. Right bifurcation bend 139 and left bifurcation bend 141 are at angles of less than 70° and connect angle point 137 to creases 127 and 125. Right bifurcation bend 139 and left bifurcation bend 141 are matched with left dish top line 171 and right dish top line 173 to create a kite shaped portion 183 that generally bends up. Right handle support 119 continues to become right dish side 433. Left handle support 121 continues to become left dish side 435. Right crease bend 127, left crease bend 125, right dish side 433, and left dish side 435 provides enclosure for dish base 118. Arrows 147 shows the direction of the bend along 125 and 127. Right crease bend 127, left crease bend 125, right dish side 433, and left dish side 435 provides enclosure for dish base 118 with holes 425.

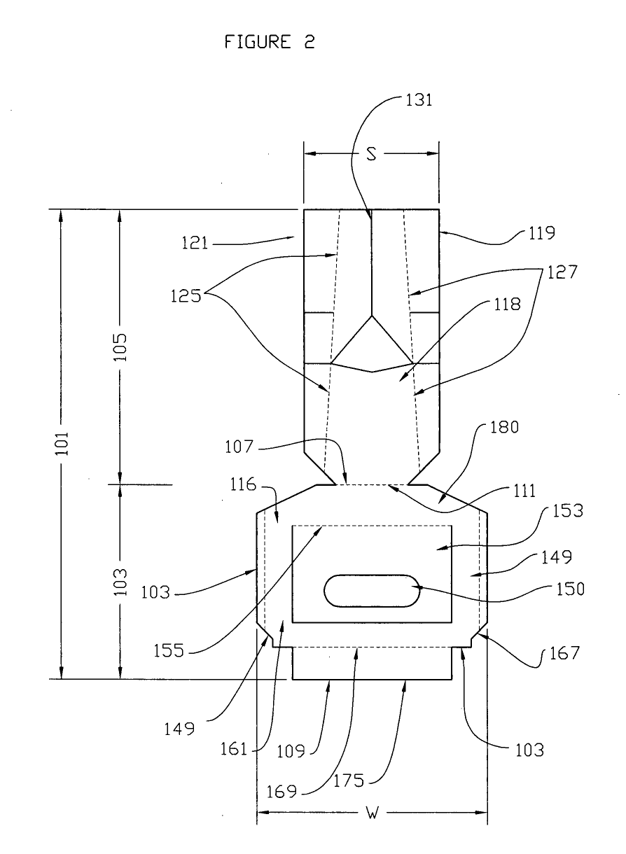

FIG. 2 shows scoop device with bag to collect cat litter waste as a flat semi rigid construct 101 with a bag box part 103 connected with perforations 107 to scoop part 105. Scoop part 105 is shown in detail in FIG. 1. Bag box part 103 has a scraper end leaf 175 which terminates in scraper end 109. Opposite scraper end 109 is perforated box end 111. Perforated end 111 is attached to top length 180 of box holder frame 149.

Bag box part 103 comprises a box holder frame 149 with a width W. Width W of box holder frame 149 is of a greater width than the width S of scoop part 105 so that box holder frame 149 is retained by bag lip 209 of bag 205 for feces. Perforated end 111 is attached with perforations 107 to top length 180 of box holder frame 149. Bag box part 103 has a scraper end 109 and a perforated end 111. Box holder frame 149 is defined by a bag holder opening door 153 which has bend line 155 which parallels perforated end 111 Bag holder opening door 153 has a hand holder slot cut opening 150.

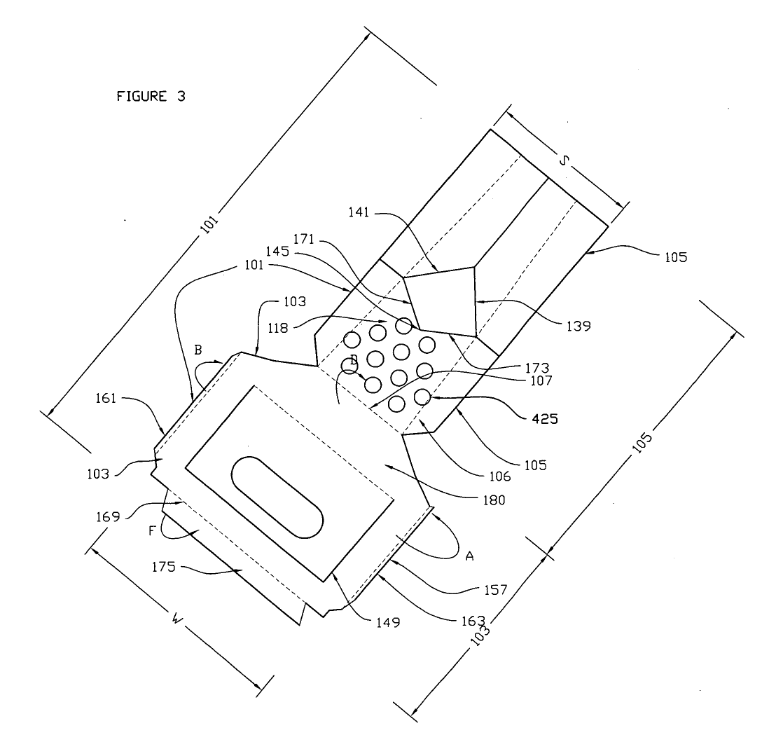

FIG. 3 shows the pattern of folds for flat semi rigid construct 101 as it is to be placed into the collection bag. Bag box part 103 top length 180 is connected with perforations 107 to scoop part 105. Box holder frame 149 has a left wing 161 and a right wing 163 Left wing 161 and right wing 163 fold downward (arrows A and B) from plane of device. Scraper end leaf 175 is attached to box holder frame 157 through leaf box bend 169. Scraper end leaf 175 is bent in an upward arrow F relative to the plane of box holder frame 157. The scoop part 105 is folded upward (arrow D) from the plane of device 101. Right bifurcation bend 139 and left bifurcation bend 141 are at obtuse angles 147 of about 135° and connect angle point 137 to creases 127 and 125. Right bifurcation bend 139 and left bifurcation bend 141 matched with left dish top line 171 connects with right dish top line 173 to create a kite shaped portion 183 that generally bends up. Right crease bend 127, left crease bend 125, right dish side 433, and left dish side 435 provides enclosure for dish base 118 with holes 425.

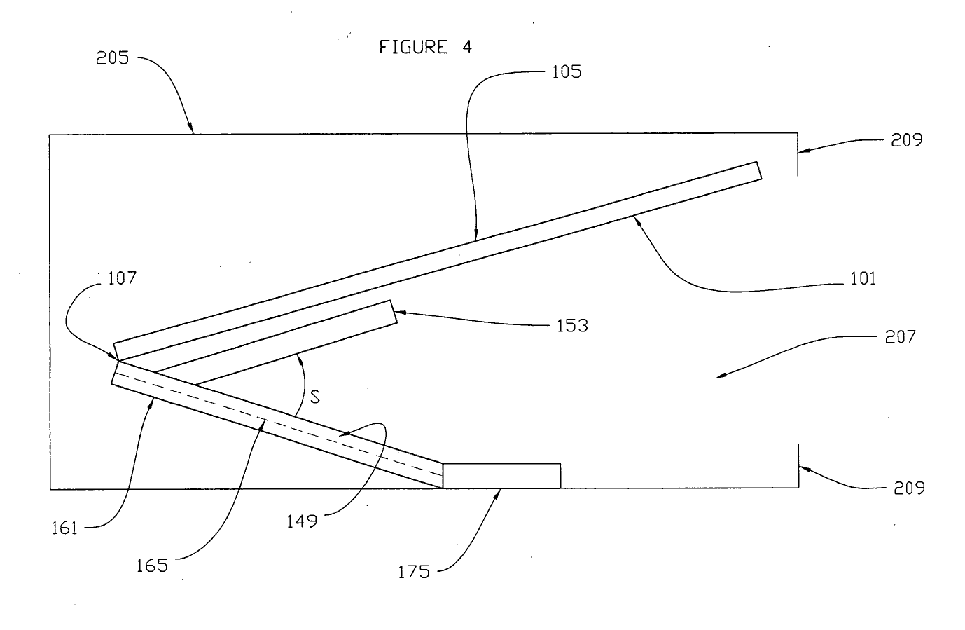

FIG. 4 shows a side views of device 105 partially folded in collection bag 205. Shown is bag 205 access hole 207. Access hole 207 is surrounded by bag lip 209. Box holder frame 149 is attached via folding line 165 with a left wing 161. Bag holder opening door 153 is shown opening in an upward angle S relative to box holder frame 149. Scoop part 105 is shown folding on the upper side of the folded construct 101.

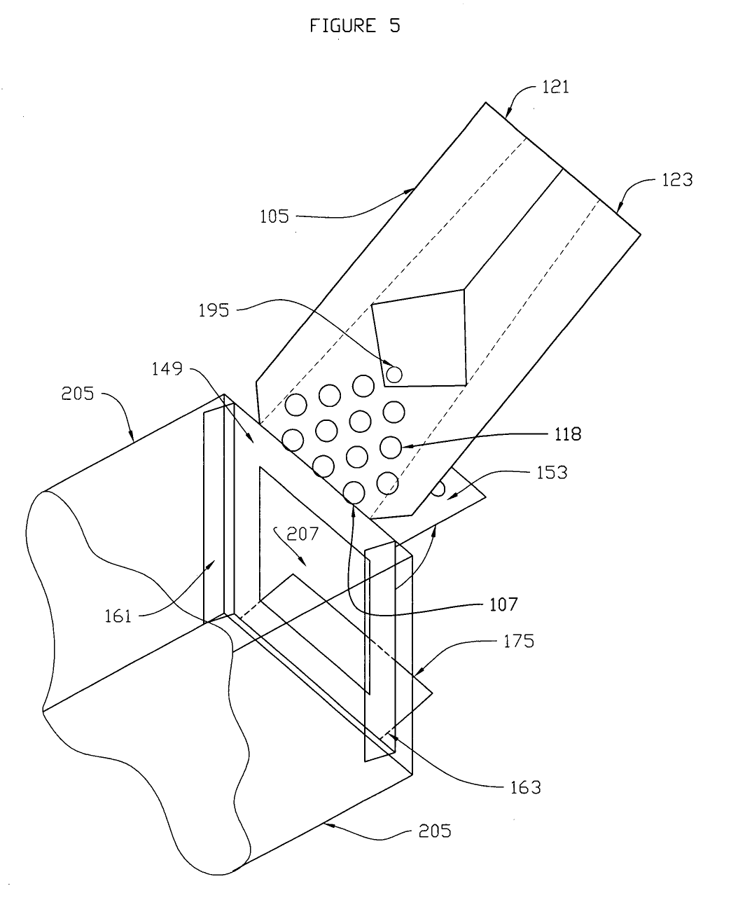

FIG. 5 shows a perspective view of device 105 partially removed from bag 205 (shown as cut off). Scraper end leaf 175 extends out of bag access hole 207. Box holder frame 149 has a left wing 161 and a right wing 163. Bag holder opening door 153 is shown. Scoop part 105 had been pulled from bag 205 and is ready to be removed from box holder frame 157 by pulling away from perforations 107. Pressure point 195 aids the folding of the scoop part.

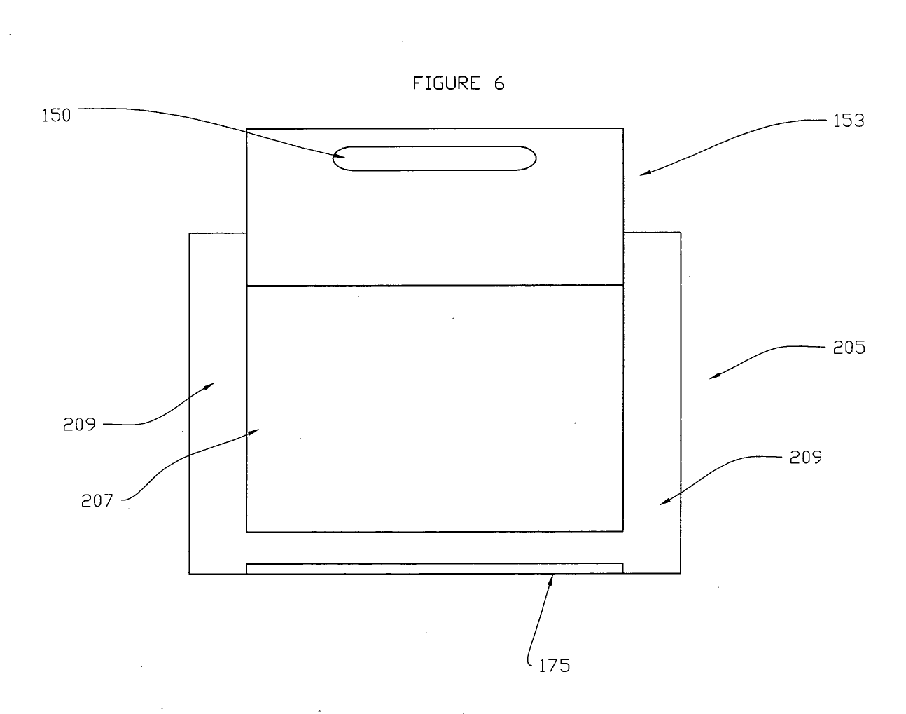

FIG. 6 shows top view of bag 205 with access hole 207. Access hole 207 is surrounded by bag lip 209. Scraper end leaf 175 is shown in outline. Bag holder opening door 153 has a hand holder slot cut opening 150.

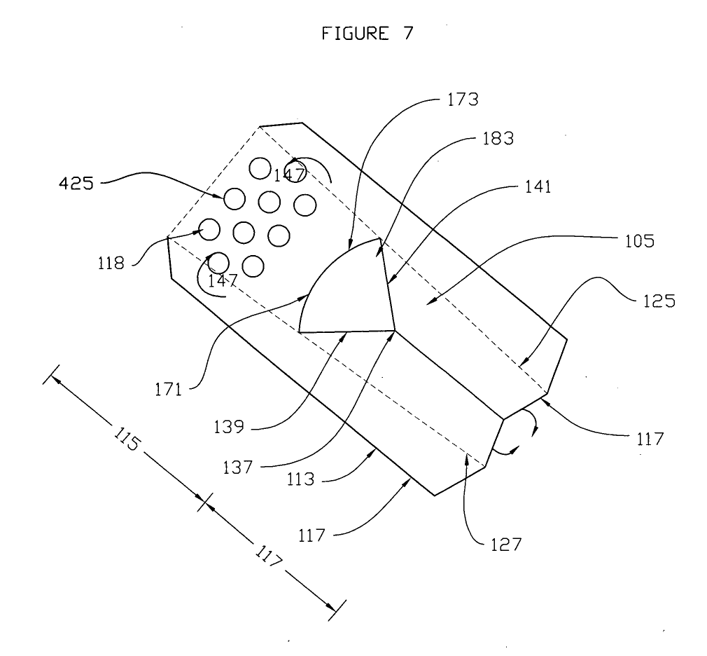

FIG. 7 shows the start of converting flat isolated scoop part 105 into a useful waste scoop with handle section 117 and dish section 115. Dish base 118 is shown. Right bifurcation bend 139 and left bifurcation bend 141 are at obtuse angles 147 of about 135° and connect angle point 137 to creases 127 and 125. Right bifurcation bend 139 and left bifurcation bend 141 matched with left dish top line 171 connects with right dish top line 173 to create a kite shaped portion 183 (with an optional semi-circular top) that generally bends up.

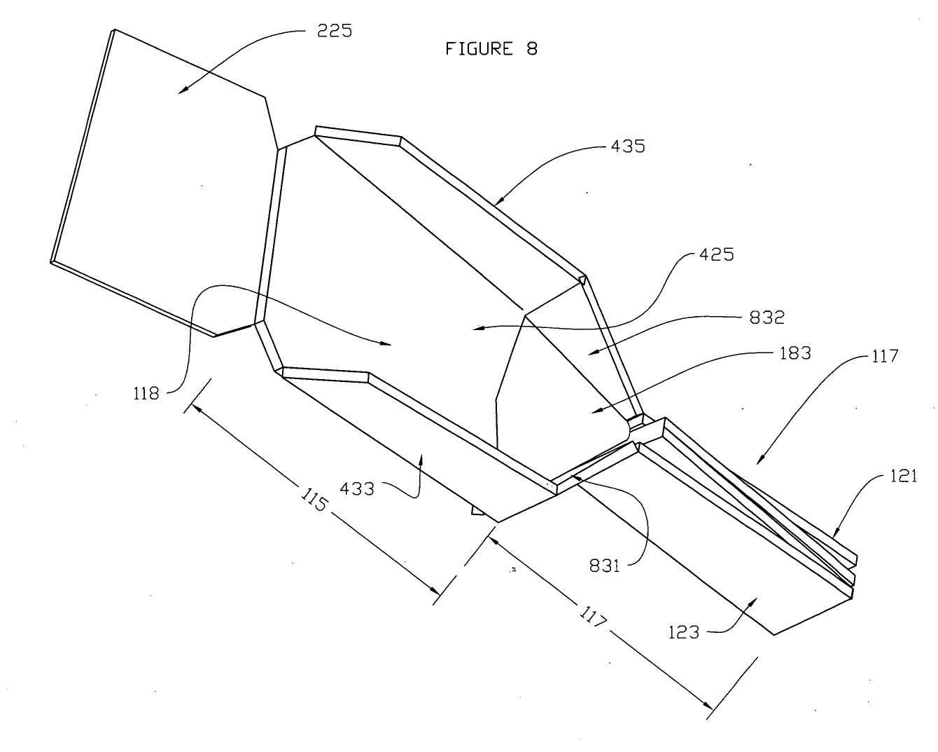

FIG. 8 shows the isolated scoop part 105 squeezed into the final form for collecting waste. Dish section 115 and shovel handle section 117 are shown. Optionally when the scoop part is manufactured without the container the dish section 115 maybe attached with perforation to a scraper part 225. Scraper part 225 can be removed to aid the gathering of waste. Right outer support 123 continues to become right dish side 433. Left outer support 121 continues to become left dish side 435. Kite shaped portion 183 with right dish shoulder 831 and left dish shoulder 832 provides the top wall of dish part 115.

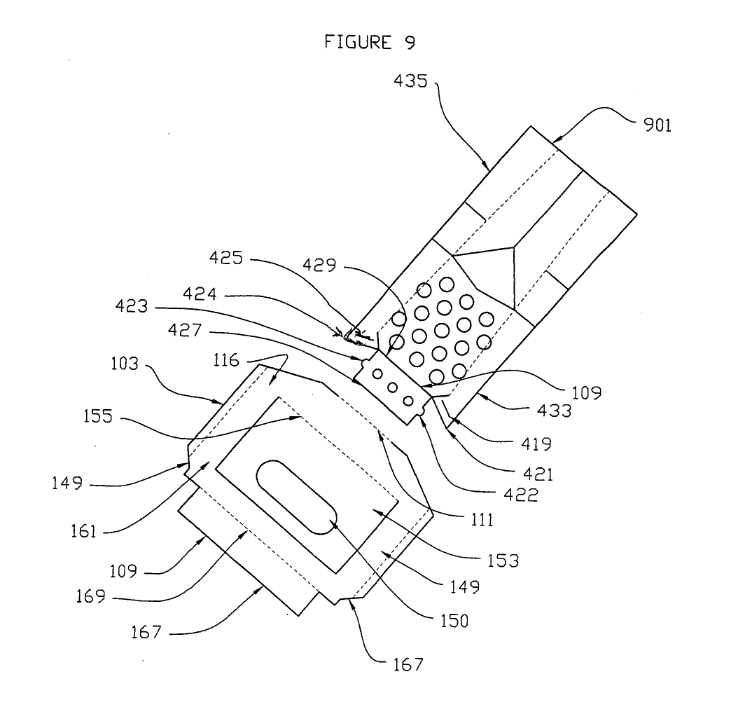

FIG. 9 shows an alternate embodiment that is a development of that the device as described in FIG. 2. This development is scoop barrier 427. The device of FIG. 8 is essentially that of FIG. 2 which shows flat semi rigid construct 901 with a bag box part 103 separated from scoop part 105. Extended from dish part end 109 with bend fold 429 is scoop barrier 427. On sides of scope barrier 427 are a first barrier tab 422 and a second barrier tab 423. Right dish side 433 extends to a first v point 421 with a first tab hole 419 which accepts first tab 422. Left dish side 435 extends to a second v point 424 with a second tab hole 425 which accepts second barrier tab 423.

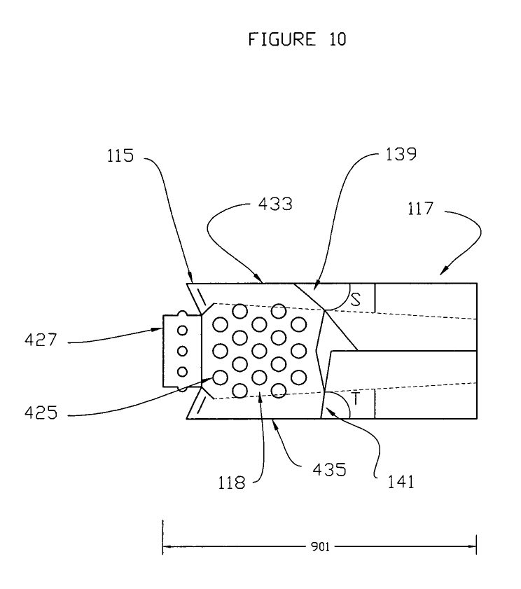

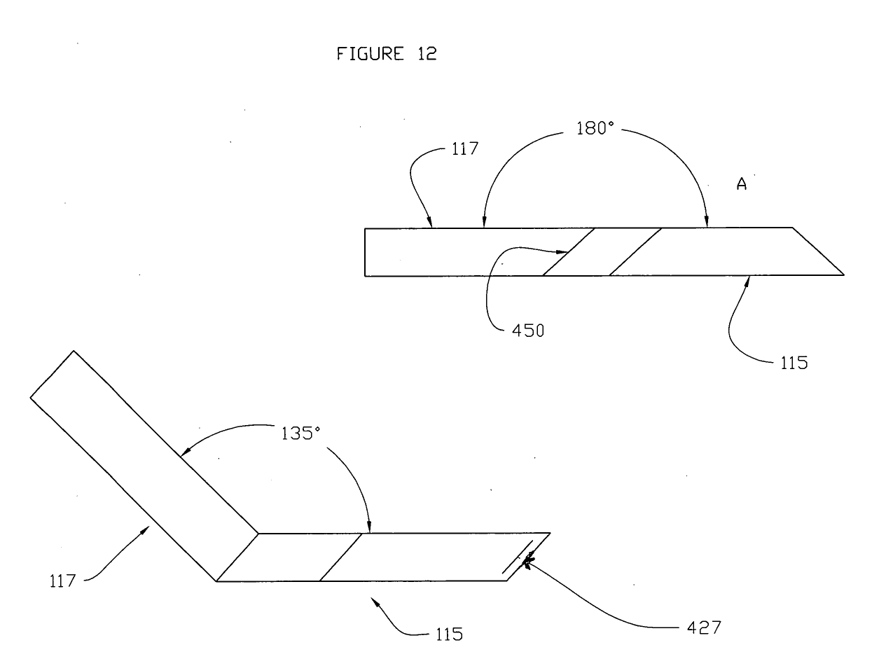

FIG. 10 shows isolated unassembled scoop device 901 with scoop barrier 427. Handle composite 917 and dish section 915 are shown. Dish base 118 has holes 425. Of interest in this illustration are right bifurcation bend 139 and left bifurcation bend 141. Note right bifurcation bend 139 has a less acute angle S that the angle T of left bifurcation bend 139. Acuteness of angles S and T determine the angle of the handle section 117 relative to the dish section 118. This is illustrated in FIG. 12.

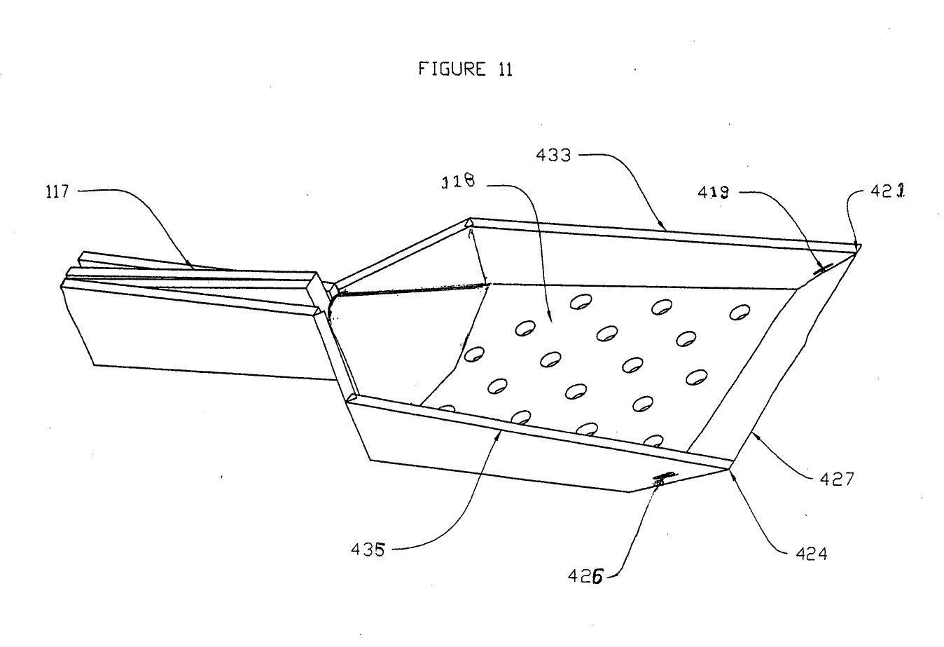

FIG. 11 shows alternate embodiment of FIG. 9 assembled for use. Scoop barrier 427 is angled upwardly. On sides of scope barrier 427 are barrier tabs 422 and 423 which are placed into tab holes 419 and 426. Right dish side 433 extends to a v point 421 with tab hole 419 which matches tab 423. Left dish side 435 extends to v point 424 with tab hole 426. Litter holes 425 in dish base 118 are shown. Kite shaped portion 183 with right dish shoulder 831 and left dish shoulder 832 provides the top wall of dish part 118.

FIG. 12 illustration A shows an assembled device 101 with a handle composite 117 and dish section 115 in a straight line assemble. Note dish section 115 and handle section are in a 180° angle and has no barrier end. From FIG. 11 angle T is about 45° to produce a scoop with an assembled angle of 180°. Illustration B shows an assembled scope with a handle composite 117 and a dish section 115 at an angle of 135°. Angle S at a 66° as shown in FIG. 11 produces the handle section 117 and dish section 118 at an angle of about 135°. Note, in illustration B assembled scoop part 105 has scoop barrier 427 in place.

We claim:

1) A scoop device to collect cat litter waste comprising:
a scoop with a dish part and a handle composite;
said handle composite is subdivided with upward foldable right handle support with a right crease to make a right center support and right outer support;
an upward foldable left handle support with a left crease to make a left center support and a left outer support;
said right center support, said left center support, said right outer support, and said left outer support are each about one-fourth the width of said handle composite;
midway between said right shovel handle section and said left shovel handle section is a handle groove that allows downward bends for said left center support and said right center support;
said handle groove extends to about one-third to one-half of said scoop part and continues as a right bifurcation bend and left bifurcation bend;
said right bifurcation bend and said left bifurcation bend are at obtuse angles and connect to said right crease line and said left crease line as an angle point;
said right handle support continues to become right dish side;
said left handle support continues to become left dish side;
said right crease bend, and said left crease bend makes a right dish shoulder and a left dish shoulder;
said right bifurcation bend and said left bifurcation bend in cooperation with a kite shaped portion created in part by said right bifurcation bend and said left bifurcation bend provide a top wall of said dish part;
said right dish shoulder, said left dish shoulder, a kite shaped portion, said right dish side and said left dish side provide walls for dish base with holes.

2) A scoop device with bag to collect and sequester cat litter box waste as in claim 1) wherein a scraper part is attached with a fold to said dish base.

3) A scoop device to collect cat litter waste as in 1) further comprising a barrier end extending from said dish base with bend fold;
on sides of said scope barrier are a first and a second barrier tabs;
said right dish side extends to a first v point with a first tab hole which receives said first barrier tab;
left dish side extends to second v point with a second tab hole which receives said second barrier tab.

4) A scoop device to collect and sequester cat litter box waste comprising;
a scope part and a bag box part;
said scoop part; a scoop with a dish part and a handle composite;
said handle composite is subdivided with upward foldable right handle support with a right crease and an upward foldable left handle support with a left crease;
a right center support and a left center support;
said right crease, said left crease, said right center support, and said left center support;
are each about one-fourth the width of said handle composite;
midway between said right shovel handle section and said left shovel handle section is a handle groove that allows downward bends for said left center support and said right center support;
said handle groove extends to about one-third to one-half of said scoop part and continues as a right bifurcation bend and left bifurcation bend;
to said right crease line and said left crease line as an angle point;
said right handle support continues to become right dish side;
said left handle support continues to become left dish side;
said right crease bend, and said left crease bend makes a right dish shoulder and a left dish shoulder;
said right bifurcation bend and said left bifurcation bend along with a kite shaped portion created in part by said right bifurcation bend and said left bifurcation bend provide a top wall of said dish part;
said right dish shoulder, said left dish shoulder, a kite shaped portion, said right dish side and said left dish side provide walls for dish base with holes;
said dish base is connected with perforations to preformatted end of bag box part;
said bag box part has a scraper leaf end and a perforated end;
said bag box part comprises a box holder frame said frame is connected with perforations to said dish segment end of said scoop part;
said box holder frame is defined by a bag holder opening door which has a bend line proximal to said box part scraper end with perforations;
said bag holder opener has a hand slot cut opening;
opposite said perforations that connects said box holder frame to said dish segment end of said scoop part;
is a scraper end leaf that is defined by a bend slash attached to said box holder frame.

5) A scoop device to collect and sequester cat litter box waste in claim 4) further comprising a closable bag which contains said scoop and said bag holder opener.

6) A scoop device to collect and sequester cat litter box waste as in claim 4) further comprising;
a barrier end extending from said dish base with bend fold;
on sides of said scope barrier are a first and a second barrier tabs;
said right dish side extends to a first v point with a first tab hole which receives said first barrier tab;
left dish side extends to second v point with a second tab hole which receives a second of said barrier tabs.

7) A scoop device to collect and sequester cat litter box waste as in claim 4) further comprising;
one or more disposable gloves.

8) A scoop device to collect and sequester cat litter box waste in claim 4) further comprising:
an amount of wipes.
